(19) United States
(12) Patent Application Publication
(10) Pub. No.: US 2007/0136568 A1
(43) Pub. Date: Jun. 14, 2007

(54) Method for making a bootable USB storage device

(75) Inventor: Xiao-Hua Ding, Taipei (TW)

Correspondence Address: BIRCH STEWART KOLASCH & BIRCH, PO BOX 747, FALLS CHURCH, VA, 22040-0747, US

(73) Assignee: WISTRON CORPORATION

(21) Appl. No.: 11/634,906

(22) Filed: Dec. 7, 2006

(30) Foreign Application Priority Data
Dec. 9, 2005 (TW) 094143600

(51) Int. Cl. G06F 15/177

(52) U.S. Cl. 713/1

(57) ABSTRACT

The invention provides a method for making a bootable USB storage device of Windows XP operation system, which provides external bootup, can be disabled and removed after booting, and wherein the operation mode is command line. In one embodiment, the method comprises: analyzing the portable executable file in Windows XP and retrieving the image of boot disk in the PE file; analyzing the image of boot disk and retrieving the system files required by the booting process; and making the boot disk.

### FIELD OF THE INVENTION

The present invention relates to a method for making bootable USB storage device, and more particularly relates to a method for making bootable USB storage device of operation system Windows XP.

### DESCRIPTION OF THE PRIOR ART

Generally, when a computer is turned on, the computer will boot up, which means the computer loads operation system installed in the hard disk into the memory. Today the Windows series of Microsoft are the most popularly used operation systems. In special cases, if the user does not want to load the installed operation system into memory for special reasons or the user boots a computer without operation system installed, then the user has to use another disk with operation system installed to external bootup. Formerly the disks used to external bootup are bootable CD-ROM, 3.5″ soft disk, or 5.25″ soft disk, and operation systems are able to make bootable soft disks, too.

However, soft disks lack for storage space and thus disappear gradually. And CD-ROMs are neither rewritable nor convenient to make because of the necessity for recorders. Recently in all external disks of computers, the USB flash disks are popularly used because of their small volume, light weight, larger storage space than soft disks, rewritable, and supporting special chips with ability such as MP3 (MPEG layer 3) player or digital voice recorder. At the same time, there are new motherboards of computers which have the ability to support booting from USB storage devices, thus the computer hardware are able to support external bootup of USB storage devices already. On the other hand, the Windows series, even the newest operation system Windows XP, lack of supporting to make USB bootable disks except Windows 98. Thus, the users who are in need of external bootup from USB bootable disks demand a method for making USB bootable disks immediately.

### SUMMARY OF THE INVENTION

In view of the above description, it is therefore a primary object of the claimed invention to provide a method for making a bootable USB storage device, which utilizes hidden booting files of Windows XP to make a bootable USB storage device.

There is another object of the present invention to provide a method for making a bootable USB storage device, which provides external bootup, can be disabled and removed after booting, and wherein the operation mode is command line.

Following the description above, the present invention provides a method for making a bootable USB storage device, which provides external bootup, can be disabled and removed after booting, and wherein the operation mode is command line. In one embodiment, the method comprises: analyzing the portable executable file in Windows XP and retrieving the image of boot disk in the PE file; analyzing the image of boot disk and retrieving the system files required by the booting process; and making the boot disk.

### BRIEF DESCRIPTION OF THE DRAWINGS

FIG. 1 is a flow diagram that shows the method for making bootable USB device.

FIG. 2 shows the structure of the image of a boot disk.

FIG. 3 shows the system files of booting process retrieved by the step 102 of FIG. 1.

### DESCRIPTION OF THE PREFERRED EMBODIMENT

The following detailed description of the present invention describes the testing apparatuses and methods necessary to provide an understanding of the present invention, but does not cover a complete structure composition and the operating theory. The portions relating to the conventional techniques are briefly described, and the parts of the drawings are not proportionally drafted. While embodiments are discussed, it is not intended to limit the scope of the present invention. Except expressly restricting the amount of the components, it is appreciated that the quantity of the disclosed components may be greater than that disclosed.

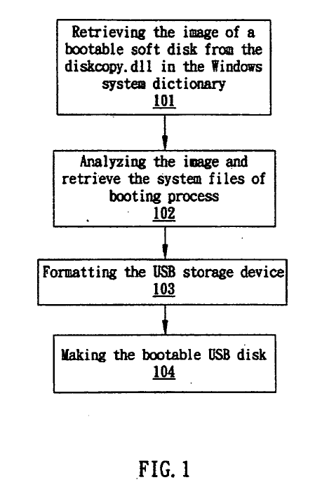

According to the prior art, the Windows XP operation system lacks of an efficient method of making a bootable USB flash disk. Thus the present invention provides a method of a bootable USB flash disk, wherein the USB flash disk can be other USB storage devices, for example, the USB hard disk and USB CD-ROM recorder. Furthermore, the embodiments of the present invention are processing in the Windows XP operation system, and it is also suitable for other similar Windows operation systems or non-Windows operation systems. Referring to Fig. 1 which is a flow diagram that shows the method of the present invention, the first step of the method is to retrieve the image of a bootable disk from the Windows system directory (Step 101). In the embodiments of the present invention, there is a diskcopy.dll file in the sub-directory system32 of the Windows XP operation system directory, where the DLL (dynamic link library) format is one of the PE (portable executable) file formats. Thus the resource of the DLL file can be retrieved in accordance with the structure of PE files. By analyzing the diskcopy.dll, the image of a bootable disk can be retrieved in the resource of the diskcopy.dll that the entry point of the image can be found in the header of the PE file. The analysis can be processed by existing software. In this embodiment of the present invention, the image is an image file named BINFILE which is an image of a bootable soft disk (1,44 MB soft disk). Although the analyzed file in Step 101 is a PE file, the present invention is not limited to PE files only.

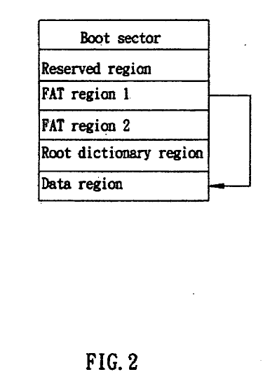

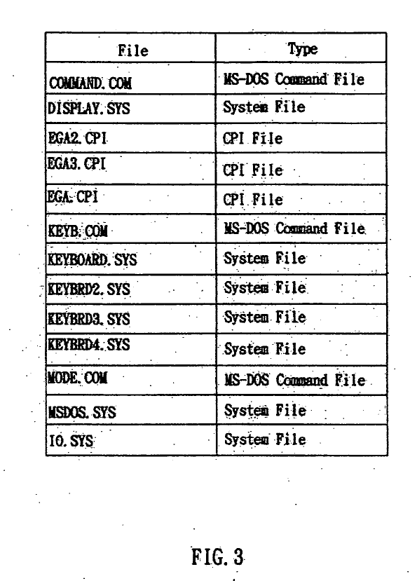

The next step (step 102) is to analyze the image and retrieve the system files of booting process. The image is analyzed by utilizing the file system, such as file allocation table (FAT). In this embodiment, the image file named BINFILE is analyzed by utilizing FAT12. FIG. 2 shows the structure of the image of a bootable disk, which comprises a boot sector, a reserved region, FAT region 1, FAT region 2, a root directory region, and a data region. Because the BINFILE is a full image of a bootable 1.44 MB soft disk, the data of the BINFILE equals to the practical data of the bootable soft disk. Thus the BINFILE fits the FAT format of the bootable disk. In this embodiment, the system files of booting process are found and retrieved by utilizing the FAT, and the link between FAT and system files is shown as the arrow in FIG. 2. The files retrieved are shown in FIG. 3, which comprises the system files required by booting process, such as IO.SYS, MSDOS.SYS, and COMMAND.COM of Windows XP version, and other files.

Referring to FIG. 1, the following step 103 is to format the USB storage device, for example, high-level format a USB flash disk. In this embodiment of the present invention, the structure of the disk after format will be the same as FIG. 2, which comprises a boot sector, FAT region 1, FAT region 2, a root directory region, and a data region at least. The file system can be FAT16 and if the storage capacity of the USB storage device is over 2GB, the file system can be FAT32. In other embodiments, other files systems can be applied.

The last step (step 104) is to make the bootable USB disk. The files retrieved in step 102 are copied to the root directory of the USB storage device, and bootstrap (or initial program loader) is made in the boot sector of the USB storage device, wherein the system files required by booting process, such as IO.SYS, MSDOS.SYS, and COMMAND.COM and other files are placed in the root directory and data regions of the USB storage device. In booting process, after the USB storage device is connected to the computer and the computer is turned on, the programs in the boot sector will be loaded into the main memory of the computer, and then the system files in the root directory are loaded. Thus the initial process of booting is finished.

According to the method described above, the present invention utilizes the files in Windows XP system directory to retrieve system files which can be used to make bootable disk. Thus the demand of a method for making USB bootable disks is satisfied.

The bootable USB storage device made by the method of the present invention provides external bootup for computer systems, can be disabled and removed after booting, and wherein the operation mode is command line. The present invention is not limited to USB flash disk but can be applied to USB storage device, such as USB hard disk and USB CD-ROM recorder. Whether the computer system has any disk or storage device which has operation system installed or not, the bootable USB storage device made by the method can work if the BIOS (basic input output system) of the computer support booting of the bootable USB storage device.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

What is claimed is:

1. A method for making a bootable USB storage device, comprising:
retrieving an image of a boot disk from an operation system;
retrieving a plurality of system files which can be used in booting process from said image of said boot disk; and
utilizing said plurality of system files to make said USB storage device a bootable disk.

2. The method according to claim 1, wherein said image of said boot disk is extracted from a portable executable file.

3. The method according to claim 2, wherein said portable executable file is diskcopy.dll.

4. The method according to claim 3, wherein said diskcopy.dll is in sub directory \%windows\system32 of said operation system.

5. The method according to claim 3, wherein said operation system is Windows XP.

6. The method according to claim 2, wherein said image of said boot disk is an image file of a bootable 1.44 MB soft disk.

7. The method according to claim 6, wherein said image file of a bootable 1.44 MB soft disk is named BINFILE.

8. The method according to claim 1, wherein said plurality of system files are retrieved by analyzing a FAT of said image of said boot disk.

9. The method according to claim 1, wherein said plurality of system files comprises COMMAND.COM, IO.SYS, and MSDOS.SYS.

10. The method according to claim 1, wherein said plurality of system files comprises COMMAND.COM, IO.SYS, MSDOS.SYS, DISPLAY.SYS, EGA.CPI, EGA2.CPI, EGA3.CPI, KEYB.COM, KEYBOARD.SYS, KEYBRD2.SYS, KEYBRD3.SYS, KEYBRD4.SYS, and MODE.COM.

11. The method according to claim 1, further comprising:
formatting said USB storage device before utilizing said plurality of system files to make said USB storage device a bootable disk.

12. The method according to claim 11, wherein file system of formatting said USB storage device is FAT16 or FAT32.

13. The method according to claim 1, wherein said USB storage device is a USB flash disk.

14. The method according to claim 1, wherein the step of utilizing said plurality of system files to make said USB storage device a bootable disk comprises:
making bootstrap in a boot sector of said USB storage device.

15. The method according to claim 14, wherein the step of utilizing said plurality of system files to make said USB storage device a bootable disk further comprises:
placing said plurality of system files in root directory and data region of said USB storage device.
